(19) United States
(12) Patent Application Publication
(10) Pub. No.: US 2007/0022014 A1
(43) Pub. Date: Jan. 25, 2007

(54) METHOD OF MANAGING ONLINE SHOPPING MALL HAVING TRADE TRANSACTION FUNCTION

(76) Inventor: SUNG MO LEE, Incheon (KR)

Correspondence Address: PARK LAW FIRM, 3255 WILSHIRE BLVD, SUITE 1110, LOS ANGELES, CA, 90010, US

(21) Appl. No.: 11/162,205

(22) Filed: Aug. 31, 2005

(30) Foreign Application Priority Data
Jul. 21, 2005 (KR) 10-2005-0066228
Jul. 21, 2005 (KR) 10-2005-0066232
Jul. 21, 2005 (KR) 10-2005-0066233
Jul. 21, 2005 (KR) 10-2005-0066237

(51) Int. Cl. G06Q 30/00

(52) U.S. Cl. 705/26

(57) ABSTRACT

The present invention relates to a method of managing an online shopping mall having a trade transaction function, wherein the same product is displayed in association with a third nation's online shopping mall and trade-related information is continuously provided to sellers. The method includes a first process of, if information by an administrator or a seller, processing the data, registering the data as a selling product and providing the registered data to a purchaser; a second process of requesting the purchaser to input a delivery address, and calculating a delivery price of the product; a third process of summing the delivery/product prices and requesting the purchaser to pay a settlement, and if information by the purchaser, performing electronic settlement; and a fourth process of transmitting a delivery request signal to the seller, and if the delivery address is in the third nation, providing trade related information to the seller.

### BACKGROUND OF THE INVENTION

1. Field of the Invention

The present invention relates to a method of managing an online shopping mall having a trade transaction function. More particularly, the present invention relates to a method of managing an online shopping mall having a trade transaction function, wherein the same product is displayed in association with a third nation's online shopping mall and trade-related information is continuously provided to sellers so that the third nation's purchasers can buy the product.

2. Background of the Related Art

Currently, an Internet-related business market has been rapidly increased. In case of electronic commerce, B to B (Business to Business) and B to C (Business to Customer) markets are annually extending more than 300%. In this case, a main type of electronic commerce on the Internet so far is B to C. This is usually performed within one nation.

Today, it is impossible to carry out an international trade transaction using an online shopping mall, but domestic demand-based transaction is performed as electronic commerce. This type of the online shopping mall has a problem in that the amount of sales is limited since it is difficult to secure customers. Accordingly, there is also a problem in that electronic commerce is not activated.

In order to address these problems, a third nation has also made an effort to secure customers. Generally, there is a need for an online international trade shopping mall in which a solution for trade is installed on a common online shopping mall solution in order to facilitate domestic demand and trade transaction. Accordingly, the applicant of the invention has filed various applications related to electronic trade.

Electronic trade has merits in that a user can easily search a number of business partner candidates and select a best trade partner and in that he or she can save expenses accompanied by the trade. Thus, there is a growing interest in electronic trade. Furthermore, recently, a variety of attempts have been made on electronic trade for the purpose of solving the entire process ranging from search of trade partners to the writing of electronic contract documents, electronic transmission, a consignment process of transaction articles, a customs clearance process and a bill settlement process using a data communication network.

An On line shopping system using a communication system that is closed in U.S. Pat. No. 5,946,665. Which is related to a search server system in an online shopping system uses a communications network to provide shopping information for a customer. When a customer wishes to refer to or buy goods, the name of the goods is used to automatically search for stores and/or malls which handle the goods. The thus obtained stores and/or malls are then indicated as a list so that the customer may easily recognize them. Further, detailed information of each store and/or mall is indicated, whereby the customer may appropriately select a store and/or mall and enter it. An indication unit in the search server system provides visual indication information to a client terminal. The visual indication information is produced from image information of the stores. The visual indication information may also be combined with respective image information of the goods from the stores.

A system and method for providing trade confirmations that is closed in U.S. Pat. No. 6,477,647. Which is related to a system and method for confirming trade transactions via the Internet and/or private network to e-mail address. An encrypted electronic envelope and a trade confirmation document contained therein are transmitted to a customer. The customer provides a personal password to decrypt the electronic envelope to open the envelope and view the trade confirmation document. The method of transmitting the electronics envelope and the trade confirmation document provides the customer a secure and convenient manner to receive the trade confirmation. Further, after the customer has opened and closed the electronic envelope, a return receipt is transmitted back to the trade confirmation system to provide immediate notice to the system that the electronic envelope was opened and closed. The present invention also includes an exception handler subsystem for handling errors associated with the trade confirmation system.

The current electronic commerce using the online shopping mall is, however, restricted to domestic demand, i.e., a corresponding nation, but cannot be applied to international trade.

In particular, electronic commerce of most international trades is generally based on B to B. Common consumers can purchase transaction articles, which are performed based on B to B, in a B to C form. It is thus difficult for small-scale business proprietors and common consumers to participate in the international trade.

### SUMMARY OF THE INVENTION

Accordingly, the present invention has been made to solve the above-mentioned problems occurring in the prior art, and it is an object of the present invention to provide a method of managing an online shopping mall having a trade transaction function, in which the same product can be displayed and sold in association with a third nation's online shopping mall.

Another object of the present invention is a method of managing an online shopping mall having a trade transaction function, wherein trade related information is continuously provided to sellers such that small-scale business proprietors, other sellers, etc. can easily take part in trade.

Further another object of the present invention is a method of managing an online shopping mall having a trade transaction function, wherein a product description written in a third nation's language is translated into a corresponding nation's language in order for purchasers to easily recognize a corresponding product.

Still another object of the present invention is a method of managing an online shopping mall having a trade transaction function, wherein when the same product is displayed and sold in association with a third nation's online shopping mall, a purchaser is required to select a delivery time to be spent, a delivery method, etc. in order to inform the purchaser of a delivery price.

Still another object of the present invention is a method of managing an online shopping mall having a trade transaction function, wherein when the same product is displayed and sold in association with a third nation's online shopping mall, a purchaser can make a payment to a local shopping mall using his or her national currency without regard to a seller's nation.

Still another object of the present invention is a method of managing an online shopping mall having a trade transaction function, wherein a purchaser is informed of an amount of money to be paid, in real time, in his or her national monetary unit based on an exchange rate posted on a product purchase date, thus improving a trade convenience of the purchaser.

To accomplish the above objects, according to the present invention, there is provided A method of managing an online shopping mall having a trade transaction function in a system including a first nation shopping mall management server located in a first nation and a third nation association server located in a third nation and connected to the first nation shopping mall management server through a communication network, wherein the first nation shopping mall management server manages an online shopping mall and has various data necessary for trade, and the third nation association server manages an additional online shopping mall, the method includes: a first process of, if information on a product to be sold is input as data by an administrator or a seller, processing the data, registering the data as a selling product and providing the registered data to a purchaser; a second process of requesting the purchaser to input a delivery address in response to a product purchase signal of the purchaser, and calculating a delivery price of the product; a third process of summing the delivery price and the product price and requesting the purchaser to pay a settlement, and if information for settlement is input by the purchaser, performing electronic settlement; and a fourth process of transmitting a delivery request signal to the seller, and if the delivery address is in the third nation, providing trade related information to the seller.

The first process comprises the step of automatically registering a corresponding selling product with the first nation shopping mall management server, in the case where the first nation shopping mall management server and the third nation association server share a database and the selling product is registered with the third nation association server.

In a system having first nation assistant shopping mall servers, which are connected to the first nation shopping mall management server through a communication network and manage their web sites associated with a web site managed by the first nation shopping mall management server in the concept of mall-in-mall, and third nation assistant shopping mall servers, which are connected to the third nation association server through a communication network and manage their web sites associated with a web site managed by the third nation association server in the concept of mall-in-mall, the first process comprises the step of, if the selling product is registered with the first nation assistant shopping mall server or the third nation assistant shopping mall server, automatically registering a corresponding selling product with the first nation shopping mall management server.

The first process comprises the step of confirming a selling area in response to the input of information on a product by the seller, and providing the seller with data necessary for trade with a corresponding nation where the product will be sold.

The first process comprises:

a first step of, if information on the selling product, which is written in the first nation's language, is input by the administrator or a common seller of the first nation, storing the information in the database without change; a second step of, if information on the selling product, which is written in the first nation's language, is input from the first nation assistant shopping mall server, storing the information in the database without change; and a third step of, if information on the selling product, which is written in the third nation's language, is input from the third nation association server, translating price information and function description information into the first nation's language, and registering the translated information with the database. In this case, the second step comprises a first step of searching the selling product registered with the first nation assistant shopping mall server, a second step of making reference to information on newly registered selling product, and a third step of storing/registering the information in the database. Preferably, the third step comprises a first step of searching the selling product registered with the third nation association server, a second step of making reference to information on newly registered selling product, a third step of storing original information in the database, a fourth step of translating price information and function description information into price information and function description information in the first nation's language, and a fifth step of storing the translated information in the database.

The second process comprises:

a first step of allowing the first nation shopping mall management server to receive a delivery address from the purchaser through an address input space, if a product purchase signal of the purchaser is input; a second step of deciding optimal delivery means and a delivery period based on an originating address and the delivery address, calculating a delivery price accordingly, and requesting the purchaser to confirm the delivery means, the delivery period and the delivery price; and a third step of requesting the purchaser to select delivery means and a delivery period if a modification signal of the purchaser is input in the second step, calculating a delivery price accordingly, and requesting the purchaser to confirm the delivery means, the delivery period and the delivery price. In this case, the third step comprises:

a first step of presenting a list of delivery means to the purchaser and requesting the purchaser to select delivery means;

a second step of presenting a list of delivery period to the purchaser and requesting the purchaser to select the delivery period; and a third step of recalculating a delivery price after the delivery means and the delivery period have been modified.

The third process comprises:

a first step of summing the delivery price and the product price, converting the delivery price and the product price into a delivery price and a product price having the monetary unit of the first nation's based on an exchange rate, and informing the purchaser of the converted delivery price and product price; a second step of providing a list of settlement means to the purchaser and requesting the purchaser to select settlement means, and if settlement means is decided, requesting the purchaser to input user information so as to perform a corresponding electronic settlement; and a third step of performing a user authentication process, and if user authentication is successfully performed, performing a normal settlement process.

### BRIEF DESCRIPTION OF THE DRAWINGS

Further objects and advantages of the invention can be more fully understood from the following detailed description taken in conjunction with the accompanying drawings in which:

FIG. 1 shows the configuration of an overall system for implementing the present invention;

FIG. 2 is a flowchart illustrating a management process of an online shopping mall according to a preferred embodiment of the present invention;

FIG. 3 is a flowchart illustrating a process of registering selling product in the online shopping mall according to a preferred embodiment of the present invention;

FIG. 4 is a flowchart illustrating a process of calculating a delivery price in the online shopping mall according to a preferred embodiment of the present invention; and

FIG. 5 is a flowchart illustrating a process of performing settlement in the online shopping mall according to a preferred embodiment of the present invention.

### DETAILED DESCRIPTION OF THE PREFERRED EMBODIMENT

The present invention will now be described in detail in connection with preferred embodiments with reference to the accompanying drawings.

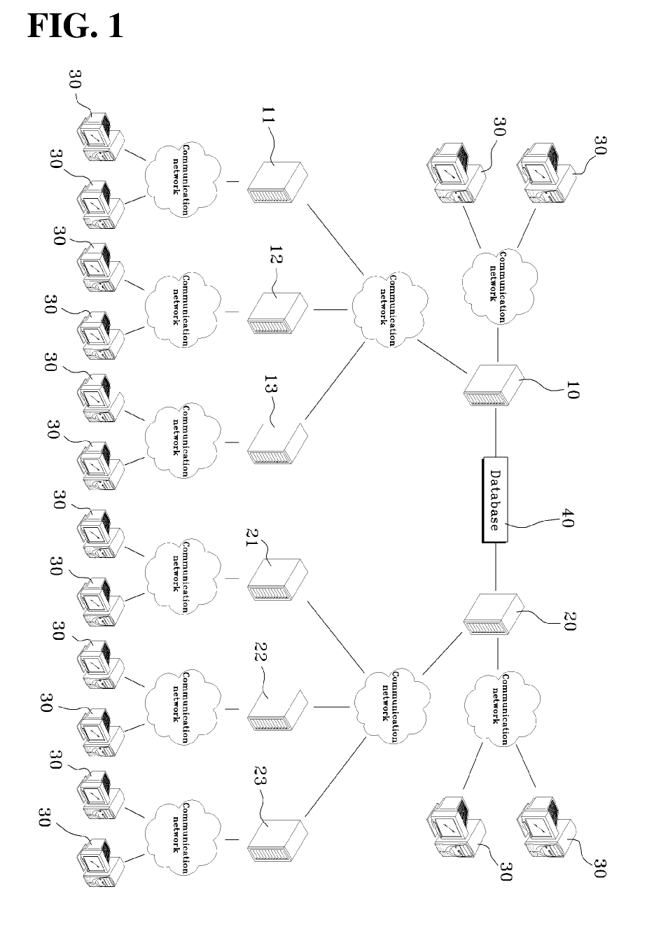

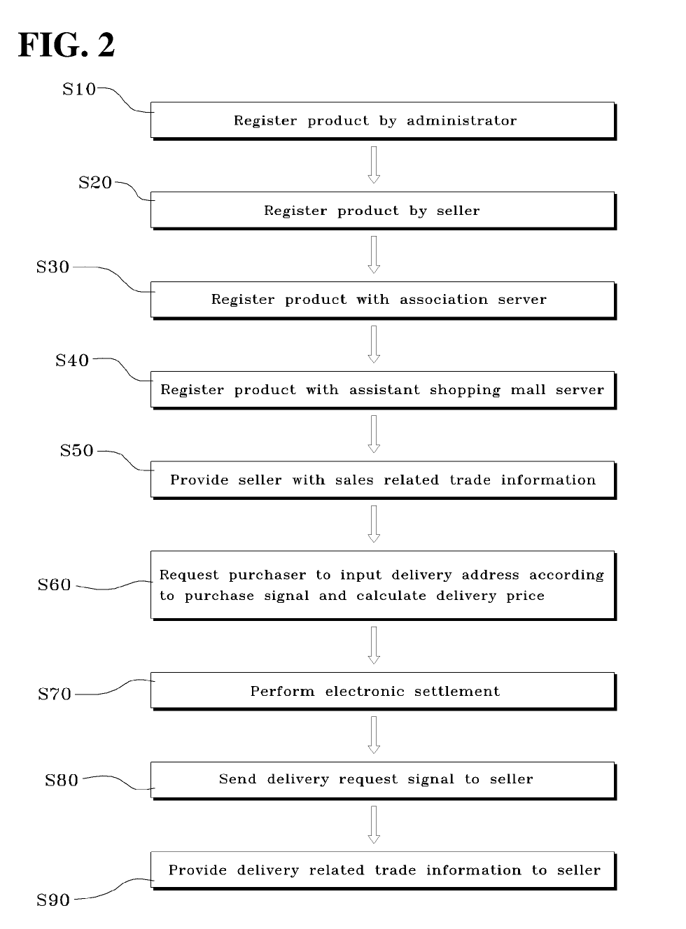

FIG. 1 shows the configuration of an overall system for implementing the present invention. FIG. 2 is a flowchart illustrating a management process of an online shopping mall according to a preferred embodiment of the present invention.

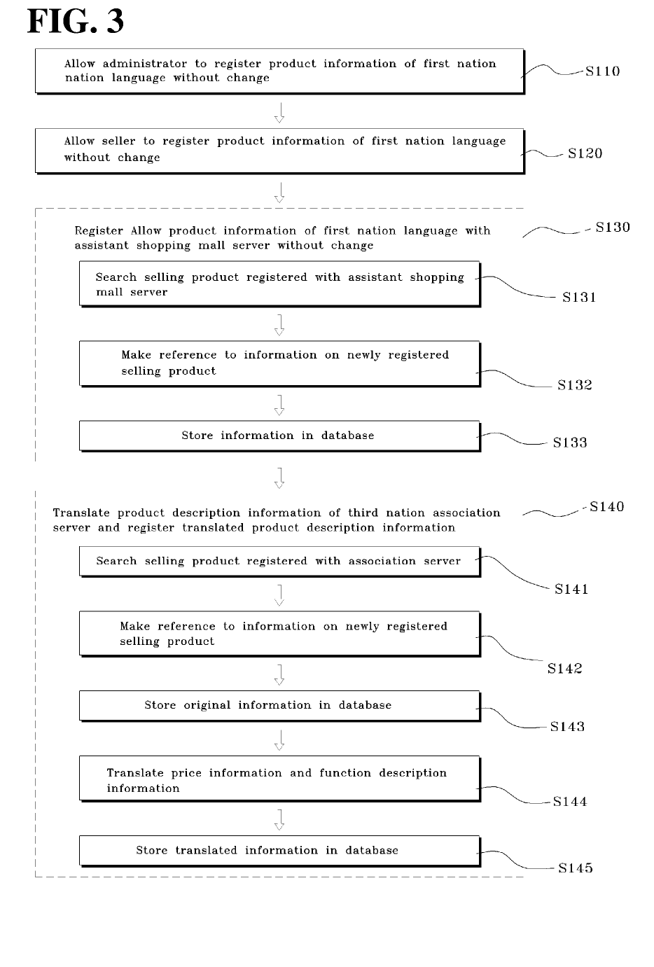

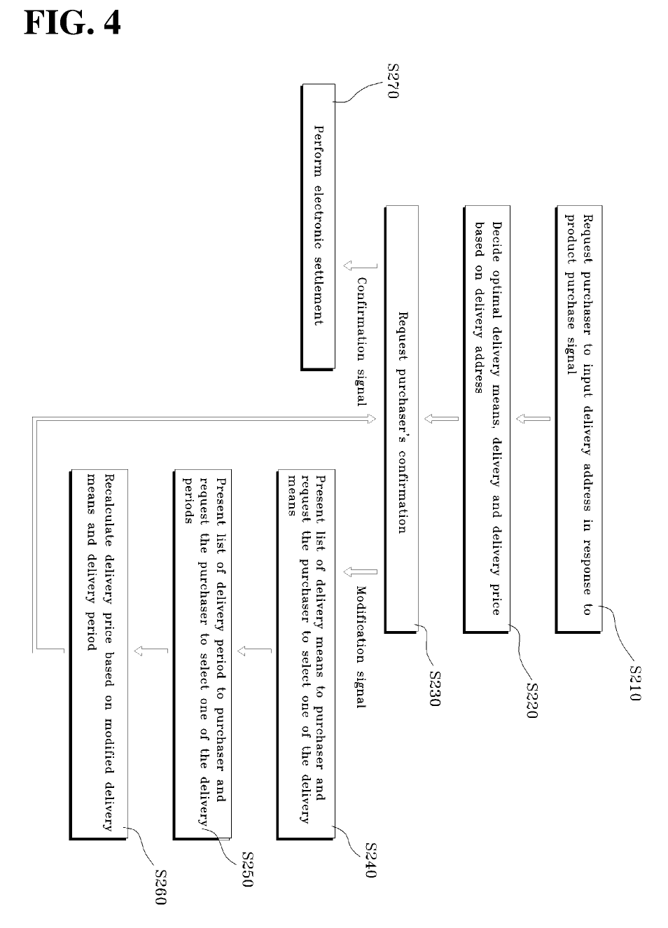

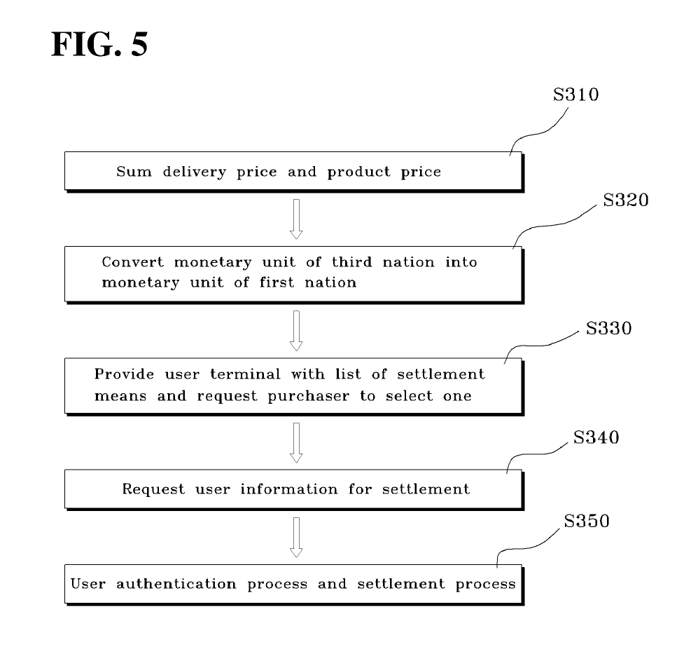

Furthermore, FIG. 3 is a flowchart illustrating a process of registering selling product in the online shopping mall according to a preferred embodiment of the present invention. FIG. 4 is a flowchart illustrating a process of calculating a delivery price in the online shopping mall according to a preferred embodiment of the present invention. FIG. 5 is a flowchart illustrating a process of performing a settlement in the online shopping mall according to a preferred embodiment of the present invention.

Referring to FIG. 1, reference numeral 10 indicates a first nation shopping mall management server. 11, 12 and 13 indicate first nation assistant shopping mall servers connected to the first nation shopping mall management server 10 through a communication network. The assistant shopping mall servers 11, 12 and 13 manage their web sites associated with a web site managed by the first nation shopping mall management server 10 in the concept of mall-in-mall.

The first nation shopping mall management server 10 is located in a first nation and has data necessary for performing a function of managing an online shopping mall and various data necessary for carrying out a trade function. The server 10 also has an operating system for providing corresponding data installed therein.

Furthermore, reference numeral 20 indicates a third nation association server, which is located in a third nation and connected to the first nation shopping mall management server 10 through a communication network. 21, 22 and 23 indicate third nation assistant shopping mall servers connected to the third nation association server 20 through a communication network. The third nation assistant shopping mall servers 21, 22 and 23 manage their web sites associated with a web site managed by the third nation association server 20 in the concept of mall-in-mall.

The first nation shopping mall management server 10 can employ a variety of methods of registering and displaying the same selling product displayed on an online shopping mall which is managed by the third nation association server 20. For example, a database 40 to be described later can be shared, registered selling product can be continuously searched and searched selling product can be automatically registered and displayed, or information on displayed selling product is received from the third nation association server 20 and is then automatically displayed.

Furthermore, reference numeral 30 indicates user terminals, which are operated by common users who can become sellers or purchasers and connected to the servers 10, 11, 12, 13, 20, 21, 22 and 23 through communication networks. The user terminals generate a purchase signal or a selling signal of product.

The database 40 is connected to the first nation shopping mall management server 10 and the third nation association server 20, and stores a variety of information such as product information and member information.

In this case, the database 40 can be separately provided in the first nation shopping mall management server 10 and the third nation association server 20. In the present invention, however, it is assumed that the database 40 is shared by the first nation shopping mall management server 10 and the third nation association server 20.

The process of managing the online shopping mall having the trade transaction function according to the present invention, which is applied to the system constructed above, will be described in detail with reference to the flowchart of FIG. 2.

The concept of the present invention will be first described in short. The management process of the present invention can be applied to an online shopping mall, which can be managed in a first nation, but can be managed in association with a number of the first nation assistant shopping malls as well as the third nation's online shopping mall. More particularly, in the online shopping mall according to the present invention, small-scale business proprietors or common sellers can be provided with a variety of information so that they can perform the trade transaction function by selling a product to foreign consumers or business proprietors.

The online shopping mall according to the present invention has a process of displaying and selling product, which is partially similar to that of a common process of managing an online shopping mall. Thus, only a difference between them will be described below.

The first nation shopping mall management server 10 according to the present invention registers a product to be sold by an administrator (S10), registers a product to be sold by common sellers (S20), and automatically registers product which is registered with the third nation association server 20, the first nation assistant shopping mall servers 11, 12 and 13, and the third nation assistant shopping mall servers 21, 22 and 23 (S30, S40).

A common user can gain access to the first nation shopping mall management server 10 through the user terminal 30, search product, and purchase or sell desired product. In this case, if the common user inputs information on product to be sold, the first nation shopping mall management server 10 confirms a selling area of the product. If the common user wants his product to be sold in a third nation, the first nation shopping mall management server 10 provides the seller with data necessary for trade with a corresponding nation in relation to the selling (S50).

Thereafter, if a purchaser who has gained access to the first nation shopping mall management server 10 using the user terminal 30 of the first nation decides to purchase the product, a typical process of managing an online shopping mall is performed. If a purchaser who has gained access to the first nation shopping mall management server 10 using the user terminal 30 of the third nation decides to purchase the product, however, the first nation shopping mall management server 10 requests the purchaser to input a delivery address in response to a product purchase signal from the purchaser and then calculates a delivery price (S60).

Next, the first nation shopping mall management server 10 sums the delivery price and the product price and then requests the purchaser to pay the settlement. If information on the settlement is input, the server 10 performs electronic settlement (S70). Electronic settlement can be performed using various methods such as common credit card settlement, on-line transfer settlement, electronic fund transfer settlement and settlement using a mobile phone.

Thereafter, the first nation shopping mall management server 10 sends a delivery request signal to a seller (S80). If the delivery address is the third nation, the server 10 provides information necessary for trade in relation to the delivery so that the sold product can be correctly delivered (S90).

Hereinafter, the process of registering selling product, the process of calculating a delivery price and the process of performing a settlement according to the present invention will be described in detail with reference to FIGS. 3 to 5.

FIG. 3 is a flowchart illustrating a process of registering selling product in the online shopping mall according to a preferred embodiment of the present invention.

As described above with reference to FIG. 2, the first nation shopping mall management server 10 registers product to be sold by an administrator (S10), registers product to be sold by common sellers (S20), and automatically registers product which is registered with the third nation association server 20, the first nation assistant shopping mall servers 11, 12 and 13, and the third nation assistant shopping mall servers 21, 22 and 23 (S30, S40).

Referring to FIG. 3, if selling product is registered, information on the selling product include image information, price information, function description information, etc. The first nation shopping mall management server 10 stores the information on the selling product in the database 40. When provided to the purchaser, the image information, price information and function description information are combined and then displayed on one page.

At this time, the image information part can use the same information regardless of the nation, but the price information and function description information parts can be different according to the nation's language. Therefore, the first nation shopping mall management server 10 can manage the image information, price information and function description information individually.

The first nation shopping mall management server 10 first determines who is the subject who registers selling product. If it is determined that the subject is an administrator or a common seller of the first nation, the server 10 stores it in the database 40, without change, since information on the selling product is written in a language of the first nation (S110, S120).

Meanwhile, in the case where information on the selling product is input and registered from the first nation assistant shopping mall servers 11, 12 and 13, it is stored in the database 40, without change, since it is written in a language of the first nation (S130). In this case, step 130 includes the steps of searching selling product registered with the first nation assistant shopping mall servers 11, 12 and 13 (S131), making reference to information on newly registered selling product (S132) and is then stored in the database 40 (S133).

Furthermore, in the case where the product registered with the third nation association server 20 or the third nation assistant shopping mall servers 21, 22 and 23 is automatically registered through the communication network, price information and function description information are translated into the first nation's language and then stored in the database 40 since information on the product is written in the third nation's language (S140). Even in this case, although information on the product is written in the third nation's language, it is stored in the database 40 without change so that it can be provided to a purchaser who wants to see original information. That is, step 140 includes the steps of searching selling product registered with the third nation association server 20 (S141), calling information on newly registered selling product (S142), storing original information in the database 40 (S143), translating price information and function description information into the first nation's language S144), and storing the translated information in the database 40 (S145).

In the above, the translation process into the first nation's language can be automatically performed. In order to improve reliability, however, price information and function description information can be provided to an administrator terminal and are then translated into the first nation's language by means of the administrator.

As such, the location of information on the selling product stored in the database 40 is determined according to an access signal of the user terminal 30, so that sales product information written in a corresponding nation's language can be provided.

In the above, the priority for the display of information on the selling product is assigned. Product information translated into a corresponding first nation language is called and displayed. If product information translated into the first nation language does not exist, product information written in English is called and displayed. If product information written in English does not exist, original information can be called and displayed.

Meanwhile, FIG. 4 is a flowchart illustrating a process of calculating a delivery price in the online shopping mall according to a preferred embodiment of the present invention.

As described above with reference to FIG. 2, the first nation shopping mall management server 10 requests the purchaser to input the delivery address in response to the product purchase signal of the purchaser and then calculates the delivery price (S60).

Referring to FIG. 4, the first nation shopping mall management server 10 receives the delivery address input by the purchaser according to the purchaser's product purchase signal (S210).

If the delivery address is input through the above process, the first nation shopping mall management server 10 decides optimal delivery means and a delivery period based on an address of the seller, i.e., an originating address and an address of the purchaser, i.e., the delivery address, calculates a delivery price accordingly, and displays it on the user terminal 30 of the purchaser (S220).

At this time, the server 10 requests the purchaser to confirm the delivery means, the delivery period and the delivery price or to decide whether to modify the delivery means and the delivery period (S230).

If a confirmation signal is input by the purchaser at step S230, the first nation shopping mall management server 10 proceeds to step S70 of FIG. 2, wherein the electronic settlement process is performed. If a modify signal to modify the delivery means and the delivery period is input by the purchaser at step S230, the first nation shopping mall management server 10 presents a list of the delivery means and requests the purchaser to select one from the list (S240). At this time, the delivery means can include transport by land, transport by sea, transport by air, transport of combination thereof, and the like.

After the delivery means is selected by the purchaser, the first nation shopping mall management server 10 presents a list of the delivery period and requests the purchaser to select one from the list (S250). At this time, the delivery period can include day delivery, next day delivery, common delivery, and so on.

If the delivery means and the delivery period are successfully modified through the above process, the first nation shopping mall management server 10 recalculates a delivery price based on the modified information (S260) and then proceeds to step S230, wherein the purchaser is requested to confirm the delivery means, the delivery period and the delivery price.

In the case where the nation of the originating address and the nation of the delivery address are different from each other and their monetary units are also different from each other when the delivery price is confirmed, the purchaser can confirm them in a national currency according to an exchange rate posted on a corresponding date.

Meanwhile, FIG. 5 is a flowchart illustrating a process of performing a settlement in the online shopping mall according to a preferred embodiment of the present invention.

As described above with reference to FIG. 2, the first nation shopping mall management server 10 requests the purchaser to perform a settlement in which the delivery price and the product price are summed. If information for the settlement is input by the purchaser, the first nation shopping mall management server 10 performs electronic settlement (S70).

This will be described in detail with reference to FIG. 3. If confirmation signals for the delivery means, the delivery period and the delivery price are input from the user terminal 30, the first nation shopping mall management server 10 sums the delivery price and the product price (S310).

The summed price is the monetary unit of the third nation. Thus, the first nation shopping mall management server 10 converts the monetary unit of the third nation into the monetary unit of the first nation according to an exchange rate, and informs the purchaser of the converted monetary unit (S320). At this time, if the monetary unit of the third nation is converted into the monetary unit of the first nation according to an exchange rate, the first nation shopping mall management server 10 can perform only the process of summing the delivery price and the product price.

Thereafter, the first nation shopping mall management server 10 provides the user terminal 30 with a list of settlement means and requests the purchaser to select one from the list (S330). If settlement means is selected, the first nation shopping mall management server 10 makes requests for user information necessary for corresponding electronic settlement (S340). For example, electronic settlement means can include credit card settlement, on-line transfer settlement, electronic fund transfer settlement, settlement using a mobile phone and the like. In the case of credit card settlement, user information can include a credit card number, a valid period, a password, a resident registration number and the like.

If user information is input through the above process, the first nation shopping mall management server 10 performs a user authentication process. If user authentication is successfully performed, the server performs a normal settlement process (S350).

As described above, according to the method of managing the online shopping mall having the trade transaction function in accordance with the present invention, the same product can be displayed and sold in association with a third nation's online shopping mall. Accordingly, there is an effect in that electronic commerce can be activated.

Furthermore, trade related information can be continuously provided to sellers such that small-scale business proprietors, other sellers, etc. can easily take part in trade. Accordingly, there is an effect in that customers can be easily attracted and the amount of sales can be increased.

Furthermore, a product description written in a third nation's language can be translated into a corresponding nation's language in order for purchasers to easily know a corresponding product. Accordingly, there is an effect in that a purchaser can easily purchase product sold at a shopping mall of a third nation by confirming the product through his own language.

Furthermore, if the same product is displayed and sold in association with a third nation's online shopping mall, a purchaser is required to select a delivery time required, a delivery method, etc. in order to inform the purchase of a delivery price. Therefore, there is an effect in that dispute over a delivery price can be prevented and dissatisfaction of a purchaser can be reduced.

Furthermore, if the same product is displayed and sold in association with a third nation's online shopping mall, a purchaser can pay the cost to a local shopping mall using the national currency without regard to a seller's nation. Therefore, there is an effect in that electronic commerce can be activated.

Furthermore, a purchaser is informed of an amount of money paid, in real time, in a national monetary unit based on an exchange rate posted on a product purchase date. Accordingly, there are effects in that convenience of a purchaser can be improved and a feeling of anxiety of a purchaser can be obviated.

Furthermore, there is an effect in that small-scale business proprietors or personal purchasers can easily purchase product of a third nation.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of managing an online shopping mall having a trade transaction function in a system including a first nation shopping mall management server located in a first nation and a third nation association server located in a third nation and connected to the first nation shopping mall management server through a communication network, wherein the first nation shopping mall management server manages an online shopping mall and has various data necessary for trade, and the third nation association server manages an additional online shopping mall, the method comprises:
a first process of, if information on a product to be sold is input as data by an administrator or a seller, processing the data, registering the data as a selling product and providing the registered data to a purchaser;
a second process of requesting the purchaser to input a delivery address in response to a product purchase signal of the purchaser, and calculating a delivery price of the product;
a third process of summing the delivery price and the product price and requesting the purchaser to pay a settlement, and if information for settlement is input by the purchaser, performing electronic settlement; and
a fourth process of transmitting a delivery request signal to the seller, and if the delivery address is in the third nation, providing trade related information to the seller.

2. The method as claimed in claim 1, wherein in a system having first nation assistant shopping mall servers, which are connected to the first nation shopping mall management server through a communication network and manage their web sites associated with a web site managed by the first nation shopping mall management server in the concept of mall-in-mall, and third nation assistant shopping mall servers, which are connected to the third nation association server through a communication network and manage their web sites associated with a web site managed by the third nation association server in the concept of mall-in-mall,
the first process comprises the step of, if the selling product is registered with the first nation assistant shopping mall server or the third nation assistant shopping mall server, automatically registering a corresponding selling product with the first nation shopping mall management server.

3. The method as claimed in claim 1, wherein the first process comprises the step of automatically registering a corresponding selling product with the first nation shopping mall management server, in the case where the first nation shopping mall management server and the third nation association server share a database and the selling product is registered with the third nation association server.

4. The method as claimed in claim 3, wherein in a system having first nation assistant shopping mall servers, which are connected to the first nation shopping mall management server through a communication network and manage their web sites associated with a web site managed by the first nation shopping mall management server in the concept of mall-in-mall, and third nation assistant shopping mall servers, which are connected to the third nation association server through a communication network and manage their web sites associated with a web site managed by the third nation association server in the concept of mall-in-mall,
the first process comprises the step of, if the selling product is registered with the first nation assistant shopping mall server or the third nation assistant shopping mall server, automatically registering a corresponding selling product with the first nation shopping mall management server.

5. The method as claimed in claim 1, wherein the first process comprises the step of confirming a selling area in response to the input of information on a product by the seller, and providing the seller with data necessary for trade with a corresponding nation where the product will be sold.

6. The method as claimed in claim 1, wherein the first process comprises:
a first step of, if information on the selling product, which is written in the first nation's language, is input by the administrator or a common seller of the first nation, storing the information in the database without change;
a second step of, if information on the selling product, which is written in the first nation's language, is input from the first nation assistant shopping mall server, storing the information in the database without change; and
a third step of, if information on the selling product, which is written in the third nation's language, is input from the third nation association server, translating price information and function description information into the first nation's language, and registering the translated information with the database.

7. The method as claimed in claim 6, wherein the second step comprises a first step of searching the selling product registered with the first nation assistant shopping mall server, a second step of making reference to information on newly registered selling product, and a third step of storing/registering the information in the database.

8. The method as claimed in claim 6, wherein the third step comprises a first step of searching the selling product registered with the third nation association server, a second step of making reference to information on newly registered selling product, a third step of storing original information in the database, a fourth step of translating price information and function description information into price information and function description information in the first nation's language, and a fifth step of storing the translated information in the database.

9. The method as claimed in claim 1, wherein the second process comprises:
a first step of allowing the first nation shopping mall management server to receive a delivery address from the purchaser through an address input space, if a product purchase signal of the purchaser is input;
a second step of deciding optimal delivery means and a delivery period based on an originating address and the delivery address, calculating a delivery price accordingly, and requesting the purchaser to confirm the delivery means, the delivery period and the delivery price; and
a third step of requesting the purchaser to select delivery means and a delivery period if a modification signal of the purchaser is input in the second step, calculating a delivery price accordingly, and requesting the purchaser to confirm the delivery means, the delivery period and the delivery price.

10. The method as claimed in claim 9, wherein the third step comprises:
a first step of presenting a list of delivery means to the purchaser and requesting the purchaser to select delivery means;
a second step of presenting a list of delivery period to the purchaser and requesting the purchaser to select the delivery period; and
a third step of recalculating a delivery price after the delivery means and the delivery period have been modified.

11. The method as claimed in claim 1, wherein the third process comprises:
a first step of summing the delivery price and the product price, converting the delivery price and the product price into a delivery price and a product price having the monetary unit of the first nation's based on an exchange rate, and informing the purchaser of the converted delivery price and product price;
a second step of providing a list of settlement means to the purchaser and requesting the purchaser to select settlement means, and if settlement means is decided, requesting the purchaser to input user information so as to perform a corresponding electronic settlement; and
a third step of performing a user authentication process, and if user authentication is successfully performed, performing a normal settlement process.
